(19) United States
(12) Patent Application Publication
(10) Pub. No.: US 2022/0136540 A1
(43) Pub. Date: May 5, 2022

(54) CORNER CONNECTING STRUCTURE FOR BOX-LIKE PIPELINE OR CONTAINER OF CORRUGATED STEEL PLATES

(71) Applicant: NANJING LIANZHONG ENGINEERING TECHNOLOGY CO., LTD, Nanjing (CN)

(72) Inventor: Fujun ZHAN, Nanjing (CN)

(21) Appl. No.: 17/270,816

(22) PCT Filed: Mar. 5, 2020
(86) PCT No.: PCT/CN2020/077910

§ 371 Date: Feb. 23, 2021

(30) Foreign Application Priority Data
Jul. 24, 2019 (CN) 201910669651.2
Jul. 24, 2019 (CN) 201921166962.9

(51) Int. Cl. F16B 5/02; F16L 9/06; F16L 9/00; B65D 90/08; B65D 90/02

(52) U.S. Cl. CPC F16B 5/02; F16L 9/06; B65D 90/027; B65D 90/08; F16L 9/003

(57) ABSTRACT

A corner connecting structure for a box-like pipeline or container of corrugated steel plates comprises a pipeline formed by assembling corrugated steel wall plates. The planes of every two adjacent corrugated steel wall plates intersect along a straight line, and the corrugation directions of the corrugated steel wall plates are perpendicular to the line of intersection. At least one corrugated steel wall plate is composed of a first corrugated steel plate and a second corrugated steel plate, of which the corrugation directions are perpendicular to the line of intersection. An end surface of the first corrugated steel plate perpendicular to the corrugation direction and coplanar with the line of intersection intersects and is fixed to the second corrugated steel plate, and is then attached and connected to the adjacent corrugated steel wall plate through the second corrugated steel plate.

### TECHNICAL FIELD

The present invention relates to a corner connecting structure, and in particular to a corner connecting structure for a box-like pipeline or container of corrugated steel plates.

### BACKGROUND

The applicant has been committed to the research, production and application of assembling underground comprehensive tunnels of corrugated steel plate structure, box-like pipelines, and pools of steel structure. In the prior art, there are two types of flange for the connection at four corners between upper, lower, left and right corrugated wall plates in the cross-sectional direction of a pipeline. One is to bend the edges of corrugated steel plates into bent edge flanges for connection; and the other is to weld additional structural steel flanges to the corrugated steel plates. The first method applies to corrugated steel plates with small corrugation height; for a larger corrugation height, the bending is difficult and may easily damage the corrugation shape. For the second method, it is very difficult to ensure flat end edges of corrugated plates and structural steel flanges, and features difficulties in manufacturing and machining. Moreover, as two longitudinal structural steel flanges are required on each wall plate, the method also features a great deal of welding labor and consumption of steel plates.

### SUMMARY

Purpose: The present invention is intended to provide a corner connecting structure for a box-like pipeline or container of corrugated steel plates having advantages of good sealing effect and simple construction process.

Technical solution: The present invention comprises a pipeline formed by assembling corrugated steel wall plates, wherein the planes of every two adjacent corrugated steel wall plates intersect along a straight line, and the corrugation directions of the corrugated steel wall plates are perpendicular to the line of intersection; at least one corrugated steel wall plate is composed of a first corrugated steel plate and a second corrugated steel plate, and the corrugation directions of the first corrugated steel plate and the second corrugated steel plate are perpendicular to the line of intersection; an end surface of the first corrugated steel plate perpendicular to the corrugation direction and coplanar with the line of intersection intersects and is fixed to the second corrugated steel plate, and is then attached and connected to the adjacent corrugated steel wall plate through the second corrugated steel plate; and the first corrugated steel plate is a main plate of the corrugated steel wall plate, and the second corrugated steel plate is a corrugated end flange for the first corrugated steel plate.

The first corrugated steel plate and the second corrugated steel plate are fixed together by welding, such that the second corrugated steel plate becomes the corrugated flange for the first corrugated steel plate.

When the first corrugated steel plate and the second corrugated steel plate are welded, the end surface of the first corrugated steel plate perpendicular to the corrugation direction is cut into a corrugated curved surface, the curved surface being attached to the corrugated surface of the second corrugated steel plate and having the same corrugation shape as that of the second corrugated steel plate.

The inside of the corrugated wall of the second corrugated steel plate is attached to the end surface of the corrugated curved surface of the first corrugated steel plate, the outside is attached to the corrugated curved surface of the adjacent corrugated steel wall plate, and the second corrugated steel plate has the same corrugation shape as that of the corrugated steel wall plate.

The second corrugated steel plate and the adjacent corrugated steel wall plate are connected together using bolts.

The bolts are located outside the connection corner of the pipeline, such that water leakage of the pipeline or container can be prevented when there are bolt holes on the inside of the pipeline.

A watertight pad is provided between the second corrugated steel plate and the adjacent corrugated steel wall plate.

The angle of connection corner between the second corrugated steel plate and the first corrugated steel plate is an obtuse angle, a right angle or an acute angle.

When the first corrugated steel plate is attached to the second corrugated steel plate, the corrugation crests of the first corrugated steel plate correspond to the corrugation crests or corrugation troughs of the second corrugated steel plate, and the corrugation troughs correspond to the corrugation troughs or corrugation crests of the second corrugated steel plate.

Reinforcing ribs for connection are provided between the first corrugated steel plate and the second corrugated steel plate, wherein the reinforcing ribs located inside the pipeline are provided with holes for bolts to facilitate connection with supports inside the pipeline, and serve as supports for brackets inside the pipeline.

Advantageous effects: The present invention has the following advantages:

(1) when forming a box-like pipeline using the connection method of the present invention, one of the wall plates may not be provided with flanges, thereby reducing the number of pipeline-connecting flanges by half and saving materials;

(2) the manufacturing process for the pipeline is simplified, saving a lot of welding procedures and the cost of manufacturing;

(3) facilitating anti-corrosion processing; molten zinc can be easily removed when performing hot galvanizing on the surface; and shots and sands are unlikely accumulated when performing shot blasting; and

(4) convenience in stacking, transportation and installation, and good sealing properties.

### BRIEF DESCRIPTION OF THE DRAWINGS

FIG. 1 is a schematic diagram of a pipeline structure according to the present invention; and

FIG. 2 is a three-dimensional schematic diagram of the connection between the first corrugated steel plate and the second corrugated steel plate according to the present invention.

### DETAILED DESCRIPTION

The present invention is further described below with reference to the drawings.

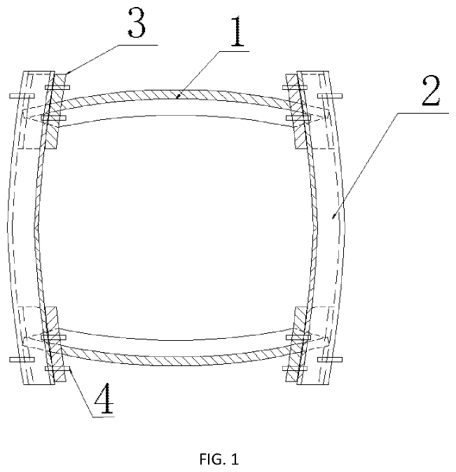

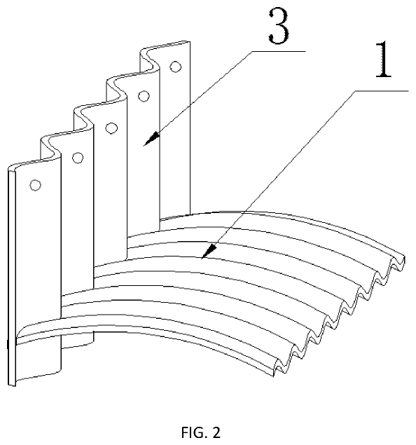

As shown in FIG. 1 and FIG. 2, the present invention discloses a corner connecting structure for a box-like pipeline or container of corrugated steel plates comprising a pipeline or container formed by assembling upper, lower, left and right corrugated steel wall plates 2. The planes of every two adjacent corrugated steel wall plates 2 intersect in a certain angle, with the intersecting line being a straight line. The corrugation directions of the corrugated steel wall plates 2 are perpendicular to the intersecting line. At least one corrugated steel wall plate 2 is composed of a first corrugated steel plate 1 and a second corrugated steel plate 3, as shown in FIG. 1. The corrugation directions of both the first corrugated steel plate 1 and the second corrugated steel plate 3 are perpendicular to the intersecting line. An end surface of the first corrugated steel plate 1 perpendicular to the corrugation direction and coplanar with the line of intersection intersects and is fixed to the second corrugated steel plate 3, and is then attached and connected to the adjacent corrugated steel wall plate 2 through the second corrugated steel plate 3, having a corrugation shape the same as that of the second corrugated steel plate 3. The first corrugated steel plate 1 is a main plate of the corrugated steel wall plate 2, and the second corrugated steel plate 3 is a corrugated end flange for the first corrugated steel plate 1. When the first corrugated steel plate 1 is attached to the second corrugated steel plate 3, the corrugation crests of the first corrugated steel plate 1 correspond to the corrugation crests or corrugation troughs of the second corrugated steel plate 3, and the corrugation troughs correspond to the corrugation troughs or corrugation crests of the second corrugated steel plate 3. The four corrugated steel wall plates 2 may be formed by the following methods:

(1) each of the upper wall plate and the lower wall plate is composed of the first corrugated steel plate 1 and the second corrugated steel plate 3, wherein one second corrugated steel plates 3 is fixed to each of the left end and right end of the first corrugated steel plate 1, and the first corrugated steel plates 1 are connected to the left corrugated steel wall plate 2 and the right corrugated steel wall plate 2 through the second corrugated steel plates 3 at the four corners, as shown in FIG. 1;

(2) each of the left wall plate and the right wall plate is composed of the first corrugated steel plate 1 and the second corrugated steel plate 3, wherein one second corrugated steel plates 3 is fixed to each of the upper end and lower end of the first corrugated steel plate 1, and the first corrugated steel plates 1 are connected to the upper and lower corrugated steel wall plate 2 through the second corrugated steel plates 3 at the four corners;

(3) each of the upper, lower, left and right wall plate is composed of the first corrugated steel plate 1 and the second corrugated steel plates 3, wherein one second corrugated steel plates 3 is fixed to each of the upper end and lower end of the four first corrugated steel plate 1, and the four wall plates are connected through the two second corrugated steel plates 3 at each corner; and

(4) each of the upper, lower, left and right wall plate is composed of the first corrugated steel plate 1 and the second corrugated steel plates 3, wherein one second corrugated steel plates 3 is fixed to one end of the four first corrugated steel plate 1, and the four wall plates are connected to the first corrugated steel plate 1 of the adjacent wall plate through the second corrugated steel plate 3 at each corner.

The first corrugated steel plate 1 and the second corrugated steel plates 3 intersect in a certain angle and are welded together, wherein the first corrugated steel plate 1 is a main plate of the corrugated steel wall plate 2, and the second corrugated steel plate 3 is a corrugated end flange for the corrugated steel wall plate 2. When the first corrugated steel plate 1 and the second corrugated steel plate 3 are welded, the end surface of the first corrugated steel plate 1 perpendicular to the corrugation direction is cut from a planar surface into a corrugated curved surface, the curved surface being attached to the corrugated surface of the second corrugated steel plate 3 and having the same corrugation shape as those of the second corrugated steel plate 3 and the corrugated steel wall plate 2; when the first corrugated steel plate 1 is attached to the second corrugated steel plate 3, the corrugation crests of the first corrugated steel plate 1 correspond to the corrugation crests or corrugation troughs of the second corrugated steel plate 3, and the corrugation troughs correspond to the corrugation troughs or corrugation crests of the second corrugated steel plate 3, as shown in FIG. 2. Reinforcing ribs for connection are provided inside the pipeline between the first corrugated steel plate 1 and the second corrugated steel plate 3, wherein the reinforcing ribs located inside the pipeline can be provided with holes for bolts to facilitate connection with supports inside the pipeline, and can serve as supports for brackets inside the pipeline.

The pipeline shown in FIG. 1 is formed by the aforementioned method (1). Two first corrugated steel plates 1 are respectively fixed between the second corrugated steel plates 3 at the lower left and lower right corners and between the second corrugated steel plates 3 at the upper left and upper right corners, and the first corrugated steel plates 1 and the second corrugated steel plates 3 intersect at a certain angle, that may be any of a right angle, an obtuse angle and an acute angle. The corrugated wall of the second corrugated steel plate 3 is attached to the corrugated curved surface on one side of the first corrugated steel plate 1, both of which are welded together, such that the second corrugated steel plate 3 becomes a corrugated flange for the corrugated steel wall plate, thereby further connecting to the corrugated steel wall plate 2 via the corrugated flange. Additional reinforcing ribs can be provided between the first corrugated steel plates 1 and the second corrugated steel plates 3 to enhance the strength of connection. The corrugated curved surfaces of the upper and lower ends of the corrugated steel wall plates 2 are respectively attached to two second corrugated steel plates 3 at the corners of the pipeline, and a plurality of bolts holes are provided at corresponding positions. The corrugated steel wall plates 2 are connected to the second corrugated steel plates 3 through bolts 4, and are thereby connected to the first corrugated steel plates 1 to form the box-like pipeline. During connection, a watertight pad can be added at the interface between the corrugated steel wall plate 2 and the second corrugated steel plate 3, and the bolt holes at the interface are located outside the connection corners of the corrugated steel plates to prevent water leakage of the pipeline or container when there are bolt holes on the inside of the pipeline, as shown in FIG. 1. Box-like pipelines formed in such methods employ a combination of welding and bolt connection for sealing at the connection corners, thereby reducing the number of pipeline-connecting flanges by half and the consumption of materials; saving a lot of welding labors and manufacturing cost; and providing good sealing properties.

The length of the second corrugated steel plate 3 may exceed that of the first corrugated steel plate 1, and steel lugs or other members may be welded at the exceeding parts as connection points for pipeline brackets.

What is claimed is:

1. A corner connecting structure for a box-like pipeline or container of corrugated steel plates, comprising a pipeline formed by assembling corrugated steel wall plates (2), wherein the planes of every two adjacent corrugated steel wall plates (2) intersect along a straight line, and the corrugation directions of the corrugated steel wall plates are perpendicular to the line of intersection; at least one corrugated steel wall plate (2) is composed of a first corrugated steel plate (1) and a second corrugated steel plate (3), and the corrugation directions of the first corrugated steel plate (1) and the second corrugated steel plate (3) are perpendicular to the line of intersection; an end surface of the first corrugated steel plate (1) perpendicular to the corrugation direction and coplanar with the line of intersection intersects and is fixed to the second corrugated steel plate (3), and is then attached and connected to the adjacent corrugated steel wall plate (2) through the second corrugated steel plate (3); and the first corrugated steel plate (1) is a main plate of the corrugated steel wall plate (2), and the second corrugated steel plate (3) is a corrugated end flange for the first corrugated steel plate (1).

2. The corner connecting structure for the box-like pipeline or container of corrugated steel plates according to claim 1, wherein the first corrugated steel plate (1) and the second corrugated steel plates (3) are fixed together by welding.

3. The corner connecting structure for the box-like pipeline or container of corrugated steel plates according to claim 1, wherein when the first corrugated steel plate (1) and the second corrugated steel plate (3) are welded, the end surface of the first corrugated steel plate (1) perpendicular to the corrugation direction is cut into a corrugated curved surface, the curved surface being attached to the corrugated surface of the second corrugated steel plate (3) and having the same corrugation shape as that of the second corrugated steel plate (3).

4. The corner connecting structure for the box-like pipeline or container of corrugated steel plates according to claim 1, wherein the inside of the corrugated wall of the second corrugated steel plate (3) is attached to the end surface of the corrugated curved surface of the first corrugated steel plate (1), the outside is attached to the corrugated curved surface of the adjacent corrugated steel wall plate (2), and the second corrugated steel plate has the same corrugation shape as that of the corrugated steel wall plate (2).

5. The corner connecting structure for the box-like pipeline or container of corrugated steel plates according to claim 1, wherein the second corrugated steel plate (3) and the adjacent corrugated steel wall plate (2) are connected using bolts (4)

6. The corner connecting structure for the box-like pipeline or container of corrugated steel plates according to claim 5, wherein the bolts (4) are located outside the connection corner of the pipeline.

7. The corner connecting structure for the box-like pipeline or container of corrugated steel plates according to claim 1, wherein a watertight pad is provided between the second corrugated steel plate (3) and the adjacent corrugated steel wall plate (2).

8. The corner connecting structure for the box-like pipeline or container of corrugated steel plates according to claim 1, wherein the angle of connection corner between the second corrugated steel plate (3) and the first corrugated steel plate (1) is an obtuse angle, a right angle or an acute angle.

9. The corner connecting structure for the box-like pipeline or container of corrugated steel plates according to claim 1, wherein when the first corrugated steel plate (1) is attached to the second corrugated steel plate (3), the corrugation crests of the first corrugated steel plate (1) correspond to the corrugation crests or corrugation troughs of the second corrugated steel plate (3), and the corrugation troughs correspond to the corrugation troughs or corrugation crests of the second corrugated steel plate (3).

10. The corner connecting structure for the box-like pipeline or container of corrugated steel plates according to claim 1, wherein reinforcing ribs for connection are provided between the first corrugated steel plate (1) and the second corrugated steel plate (3), the reinforcing ribs located inside the pipeline being provided with holes for bolts.
